(19) United States
(12) Patent Application Publication
(10) Pub. No.: US 2006/0291256 A1
(43) Pub. Date: Dec. 28, 2006

(54) LED replacement bulb and power saving device

(76) Inventor: Morgan Page Cobbler, Stuart, VA (US)

Correspondence Address: Raymond M. Galasso;Galasso & Associates LP, P.O. Box 26503, Austin, TX, 78755-0503, US

(21) Appl. No.: 11/169,266

(22) Filed: Jun. 22, 2005

(51) Int. Cl. H01R 33/00

(52) U.S. Cl. 362/640; 362/800

(57) ABSTRACT

A replacement bulb assembly for a device, such as a flashlight, with a socket configured to receive a standard filament bulb. The replacement bulb assembly includes a base assembly having an inner terminal and an outer terminal. The base assembly is configured to mate with the socket of the device. At least one LED is connected to the base assembly. The replacement bulb assembly also includes a power saver device connected to the LED to prolong the life of the power supply as well as prolong the life of the LED.

### FIELD OF THE INVENTION

The present invention relates a replacement light bulbs, more specifically but not by way of limitation to an LED replacement bulb for standard DC filament bulbs, with the LED replacement bulb utilizing power saving circuitry for prolonging the life of the power source.

### BACKGROUND

The electric light bulb help to revolutionize the world that we live in today. By making light readily available, workers were no longer limited to working from sunrise to sunset. The light bulb allowed business to be more productive by increasing the number of hours that they could be in operation.

Today, some from of light is used almost everywhere and in almost every application, such as in flashlights, automobiles, motor homes, motorcycles, buses, heavy equipment, trains, toys, eighteen wheelers, four wheelers, lawn mowers, airplanes, and jets, just to name a few.

Many of these applications utilize direct current (DC) power and some type of filament bulb. Light is created as a filament in the bulb heats up as a result of current being driven through the filament, many times powered by batteries. As can be appreciated, these filaments eventually burn out, and the batteries eventually become discharged, creating a need for each of their replacements.

Over the past few years, a number of devices have been designed to utilize new high light output LEDs instead of the standard filament bulbs. Although, this is good for newly designed devices, as can be appreciated, there are millions of devices existing and still being produced that still used the typical filament bulb. As a typical LED bulb has a life expectancy many times that of a typical filament bulb, there is a need to design a replacement LED bulb for a device designed to use a typical filament bulb.

### BRIEF DESCRIPTION OF THE DRAWING FIGURES

A more complete understanding of the present invention may be had by reference to the following Detailed Description and appended claims when taken in conjunction with the accompanying Drawings wherein:

FIG. 1 illustrates a front perspective view of a preferred embodiment of a replacement LED bulb with a power saving device shown in dashed lines in accordance with the principles of the present invention; and

FIG. 2 illustrates a preferred embodiment of a power saving circuit in accordance with the principles of the present invention.

### DETAILED DESCRIPTION

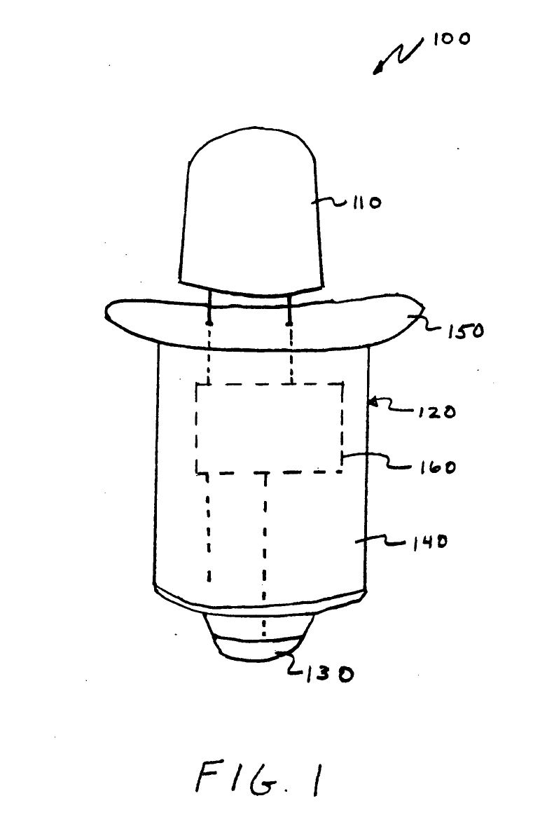

Referring now to the drawings wherein the various elements depicted are not necessarily drawn to scale, and in particular FIG. 1 there is illustrated an LED replacement bulb 100 constructed according to the principles of the present invention.

As illustrated replacement bulb 100 includes a light emitting diode (LED) 110 connected to a base assembly 120. Base assembly 120 includes an inner terminal 130 and an outer terminal 140, and a top reflective portion 150. Inner terminal 130 and outer terminal 140 for providing electrical connection between a power supply and the replacement bulb 100.

Base assembly 120 is preferably made from an electrically conductive metal according to standard practices known to those skilled in the art. In this preferred embodiment, base assembly 120 is designed as a replacement for a flashlight bulb. Although, it is contemplated to be within the scope of this invention that the shape and configuration of base assembly 120 be adapted to fit into virtually any type of existing light bulb socket where the socket is connected to a DC power supply. For example, it is contemplated that base assembly 120 could includes threads to coincide with a particular threaded bulb socket.

Although replacement bulb 100 is illustrated with a single LED, it is contemplated to be within the scope of this invention, that virtually any number of LEDs could be utilized with any particular design of base assembly 120, with the multiple LEDs configured either in parallel, series, or a parallel/series combination. It if further contemplated to be within the scope of this invention that colored LEDs could be utilized, either alone or in combination. This would, among other things, eliminate the need for colored lenses.

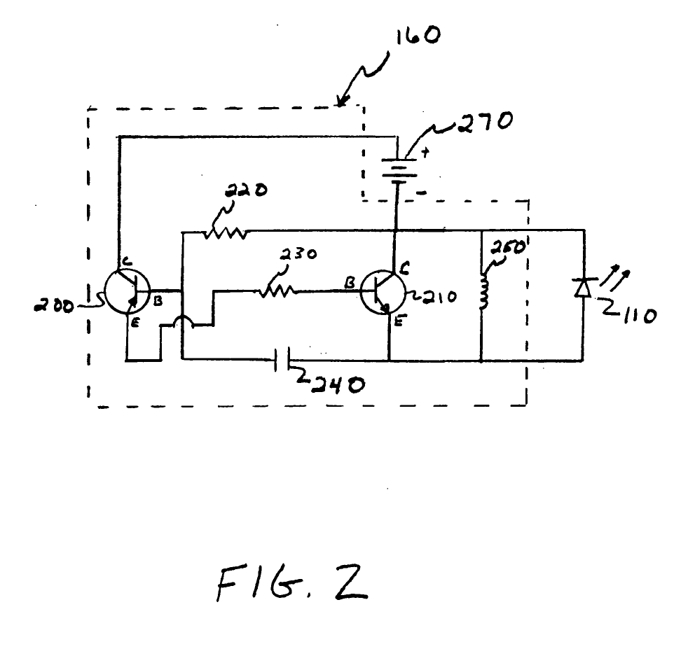

Still referring to FIG. 1, replacement bulb 100 includes a power saving device 160 (shown in dashed lines and described in more detail in FIG. 2) designed to energize LED 110 in an energy efficient manner, as well as to maximum the life of LED 110. Power saving device 160 could either be implemented on a small printed circuit board or designed into an integrated circuit.

Referring now to FIG. 2, there is illustrated a preferred embodiment of power saver circuit 160. As illustrated power saver circuit includes a PNP transistor 200, an NPN transistor 210, Resistors 220 and 230, a capacitor 240 and an inductor 250. A power supply 270 is to be connected to the collector of transistor 200 and the collector of transistor 210. LED 110 is connected in parallel with inductor 250. Resistor 220 is connected between the base of transistor 200 and the collector of transistor 210. Resistor 230 is connected between the emitter of transistor 200 and the base of transistor 210. Capacitor 240 is connected between the base of transistor 200 and the emitter of transistor 210. In operation, power saver circuit 160 save power by oscillating or pulsing LED 110 in such a manner to provide continuous appearing light.

LEDs are typically manufactured out of a variety of semiconductor materials and are comprised of a “P” and “N” type junction. The LED provides a light output when the diode is forward biased, causing current to flow through the device. The forward voltage of the diode will be different for the various materials and colors of the LED. A pulsating LED drive circuit can enhance the light output of an LED by using a peak current of a much higher level than under continuous current conditions. A high peak current pulse of short duration with an off period between pulses allows time for the LED's junction to cool down between pulses, thus prolonging the life of the LED.

As can be appreciated, the values of each of the elements of power saver circuit 160 will vary, depending on the power supply, the characteristics and the number of LEDs.

Referring now to FIGS. 1 and 2, a typical operation of the present invention will now be described. A user will have a need to replace a standard filament bulb in a flashlight. Base assembly 120 will be designed to correspond to the socket of the flashlight of the user. Replacement bulb 100 is then inserted into the socket of the flashlight. Once replacement bulb 100 is placed into the socket of the user's flashlight, and power is applied to the replacement bulb, power circuit 160 will control the energization of LED 110 in an oscillating or pulsing manner. When energized LED 110 will transmit light. Power circuit 160 will control LED 110 such that there is a continuous appearing light emitting from LED 110.

Although replacement bulb 100 is illustrated for use in a flashlight, it is contemplated to be within the scope of this invention that virtually replacement bulb 100 could be designed for use in any type of standard filament bulb, such as but not limited to, all sizes and types of flashlights, automobiles, motor homes and other motor vehicles,

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A replacement bulb for a device with a socket configured to receive a standard filament bulb, said replacement bulb comprising:
a base assembly configured to mate with the socket of the device, said base assembly including connectors for providing electrical connection between said replacement bulb and a power supply;
at least one light emitting diode (LED) connected to said base assembly, said at least one LED having an on state and an off state, said at least one LED for transmitting light when in said on state; and
an oscillator device connected to said at least one LED and the power supply, said oscillator device oscillating said at least one LED between said on state and said off state.

2. The replacement bulb as recited in claim 1, wherein said base assembly includes an inner terminal.

3. The replacement bulb as recited in claim 1, wherein said base assembly includes an outer terminal.

4. The replacement bulb as recited in claim 1, wherein said oscillator device includes an inductor connected in parallel with said at least one LED.

5. The replacement bulb as recited in claim 1, wherein said oscillator device includes a PNP transistor having a base, emitter and collector, with said collector connected to the power supply.

6. The replacement bulb as recited in claim 1, wherein said oscillator device includes a NPN transistor having a base, emitter and collector, with said collector connected to the power supply, and said at least one LED connected between said emitter and said collector.

7. The replacement bulb as recited in claim device as recited in claim 5, wherein said oscillator device includes a capacitor connected between said at least one LED and said base of said PNP transistor.

8. A replacement bulb assembly for a device with a socket configured to receive a standard filament bulb, said replacement bulb comprising:
a base assembly configured to mate with the socket of the device, said base assembly including connectors for providing electrical connection between said replacement bulb and a power supply;
at least one light emitting diode (LED) connected to said base assembly, said at least one LED having an on state and an off state, said at least one LED for transmitting light when in said on state; and
an oscillator device connected to said at least one LED and the power supply, said oscillator device oscillating said at least one LED between said on state and said off state.

9. The replacement bulb assembly as recited in claim 8, wherein said base assembly includes an inner terminal.

10. The replacement bulb assembly as recited in claim 9, wherein said base assembly includes an outer terminal.

11. The replacement bulb assembly as recited in claim 10, wherein said oscillator device includes an inductor connected in parallel with said at least one LED.

12. The replacement bulb assembly as recited in claim 11, wherein said oscillator device includes a PNP transistor having a base, emitter and collector, with said collector connected to the power supply.

13. The replacement bulb assembly as recited in claim 12, wherein said oscillator device includes a NPN transistor having a base, emitter and collector, with said collector connected to the power supply, and said at least one LED connected between said emitter and said collector of said NPN transistor.

14. The replacement bulb assembly as recited in claim 13, wherein said oscillator device includes a capacitor connected between said at least one LED and said base of said PNP transistor.

15. A replacement bulb assembly for a device with a socket configured to receive a standard filament bulb, said replacement bulb comprising:
a base assembly configured to mate with the socket of the device, said base assembly including connectors for providing electrical connection between said replacement bulb and a power supply;
at least one light emitting diode (LED) connected to said base assembly, said at least one LED having an on state and an off state, said at least one LED for transmitting light when in said on state; and
an power saving device connected to said at least one LED and the power supply, said power saving device switching said at least one LED between said on state and said off state.

16. The replacement bulb assembly as recited in claim 15, wherein said base assembly includes an inner terminal and an outer terminal.

17. The replacement bulb assembly as recited in claim 16, wherein said power saving device includes an inductor connected in parallel with said at least one LED.

18. The replacement bulb assembly as recited in claim 17, wherein said power saving device includes a PNP transistor having a base, emitter and collector, with said collector connected to the power supply.

19. The replacement bulb assembly as recited in claim 18, wherein said power saving device includes a NPN transistor having a base, emitter and collector, with said collector connected to the power supply, and said at least one LED connected between said emitter and said collector of said NPN transistor.

20. The replacement bulb assembly as recited in claim 19, wherein said power saving device includes a capacitor connected between said at least one LED and said base of said PNP transistor.
